(19) United States
(12) Patent Application Publication
(10) Pub. No.: US 2026/0198431 A1
(43) Pub. Date: Jul. 16, 2026

(54) RAISED BED STRUCTURE IMPROVEMENTS

(71) Applicant: Tawainga W. Katsvairo, Tallahassee, FL (US)

(72) Inventor: Tawainga W. Katsvairo, Tallahassee, FL (US)

(21) Appl. No.: 19/564,570

(22) Filed: Mar. 12, 2026

Related U.S. Application Data
(63) Continuation of application No. 19/408,167, filed on Dec. 3, 2025.
(60) Provisional application No. 63/727,566, filed on Dec. 3, 2024.

(51) Int. Cl. A01G 9/28; A01G 9/20

(52) U.S. Cl. CPC A01G 9/28; A01G 9/20

(57) ABSTRACT

Methods, systems, and devices for above-ground vertical farming comprising a structure including i) a bed comprising a horizontal platform at a lower end of the bed and ii) a framework coupled to the bed and configured to maintain the bed in a position elevated from a surface while the framework is in contact with the surface, wherein the platform comprises a floor surrounded by at least one wall and the bed comprises at least one flowpath configured to allow drainage of water from the lower end of the bed; and a reservoir positioned with respect to the structure with an upper end of the reservoir surrounding at least a portion of the lower end of the bed proximate the floor of the bed and a lower end of the reservoir positioned at a point lower than the bed.

### CROSS REFERENCE TO RELATED APPLICATIONS

This application is a continuation of and claims priority to U.S. patent application Ser. No. 19/408,167, filed on Dec. 3, 2025, entitled “Stacked Raised Bed Structure,” the entire disclosure of which is incorporated herein by reference in its entirety. Each of the foregoing applications claims the benefit of and priority to U.S. Provisional Patent Application Ser. No. 63/727,566, filed on Dec. 3, 2024, entitled “Stacked Bed Structure,” the entire disclosure of which is incorporated herein by reference in its entirety.

### FIELD OF THE DISCLOSURE

This disclosure generally relates to methods, structures, and devices for above-ground vertical farming in an outdoor environment.

### BACKGROUND OF THE DISCLOSURE

Raised-bed techniques for growing crops have been utilized for hundreds of years. These techniques utilize an enclosure installed on an outdoor surface such as the ground, a rooftop, or a sidewalk and filled with soil or some other plant growing medium. Typically, these beds have been constructed out of wooden boards, panels, bricks, or other conventional building materials.

The soil in raised beds may attain optimal temperature and moisture more quickly than the surrounding ground, allowing planting earlier in the spring. This is particularly advantageous for northern gardeners. Raised beds facilitate effective management of the growing environment (including easier weeding and tending of the beds) and result in improved drainage and reduced soil compaction. The improved soil conditions created in raised beds may contribute to greater yields, better quality harvest, and a generally more healthy, more productive crop. Thus, raised beds are an effective form of urban agriculture and field crop production.

### SUMMARY OF THE DISCLOSURE

In aspects, the present disclosure is related to above-ground vertical farming systems or apparauts for installation on a surface in an outdoor environment comprising a structure including i) a bed comprising a horizontal platform at a lower end of the bed and ii) a framework coupled to the bed and configured to maintain the bed in a position elevated from a surface while the framework is in contact with the surface, wherein the platform comprises a floor surrounded by at least one wall and the bed comprises at least one flowpath configured to allow drainage of water from the lower end of the bed; and a reservoir positioned with respect to the structure with an upper end of the reservoir surrounding at least a portion of the lower end of the bed proximate the floor of the bed and a lower end of the reservoir positioned at a point lower than the bed.

Systems may further comprise a growth medium contained in the bed, wherein the system is configured to introduce water from the reservoir to the growth medium when the reservoir is filled with a threshold volume of water. Systems may be configured to introduce water from the reservoir to the growth medium via capillary processes. The at least one flowpath may comprise at least one of: i) a conduit, ii) a port defined by at least one surface of the bed, iii) a capillary hole defined by at least one surface of the bed, iv) a capillary slot defined by at least one surface of the bed, and iv) a water permeable material.

The structure may be configured to enable movement of water from the reservoir into a growth medium received in the bed through capillary processes. The structure may be configured to support a load of a heavy growth medium received in the bed. The reservoir may be coupled to the framework. The reservoir may be coupled to the bed. The reservoir may comprise a container including raised sides and a plurality of substantially vertically oriented poles supporting the container in an elevated position with respect to the structure with the upper end of the reservoir surrounding at least the portion of the lower end of the bed proximate the floor of the bed and the lower end of the reservoir positioned at the point lower than the bed.

The structure may define a gap between the framework and at least a portion of the at least one wall sufficient to allow an upper end of the reservoir to be positioned between the framework and the portion of the at least one wall while surrounding the lower end of the bed proximate the floor of the bed.

In other aspects, the present disclosure is related to above-ground vertical farming systems and apparatus for attachment to a bed comprising a horizontal platform at a lower end of the bed, the platform comprising a floor surrounded by at least one wall, the bed elevated from a surface in an outdoor environment. These systems and apparatus may include a reservoir comprising an alignment means to align the reservoir elevated from the surface with an upper end of the reservoir surrounding at least a portion of the lower end of the bed proximate the floor of the bed and a lower end of the reservoir positioned at a point lower than the bed. These systems and apparatus may include a framework adapted for connection to the bed and configured to maintain the bed in a position elevated from the surface while the framework is in contact with the surface.

In other aspects, the present disclosure is related to modular above-ground vertical farming structures for use in an outdoor environment comprising a rigid top bed; at least one rigid shaded bed; and a framework adapted for mechanical coupling to the top bed and the at least one shaded bed such that, when coupled, the framework supports the top bed and the at least one shaded bed and maintains the top bed and the at least one shaded bed in vertically stacked alignment, the framework comprising a plurality of supports; wherein the top bed and the at least one shaded bed each comprise a horizontal platform with a top surface surrounded by at least one wall and configured to support a load of a heavy plant growth medium received in each of the top bed and the at least one shaded bed; and a reservoir coupled to the structure and configured to prevent water percolating from the rigid top bed to the at least one rigid shaded bed. The structure may be configured to introduce water from the reservoir to the heavy growth medium when the heavy growth medium is in the bed and the reservoir is filled with a threshold volume of water. The structure may be configured to introduce water from the reservoir to the growth medium via capillary processes.

In other aspects, the present disclosure is related to above-ground vertical farming structures for use in an outdoor environment. The structures may include two vertically stacked enclosures, wherein each enclosure comprises: a lower section configured to receive a plant growing medium, the lower section comprising a horizontal floor and a plurality of wall sections at the perimeter of the horizontal floor; a ceiling opposing the horizontal floor; and supports connecting the ceiling and the lower section; wherein each enclosure defines a plurality of openings permitting the exchange of air within an interior space defined by the enclosure and fresh air from outside the interior space. The dimensions of the plurality of openings may allow direct sunlight to reach the center of the bed for at least a threshold exposure time when the structure is installed on an earth surface at sea level with open sky.

In aspects, the present disclosure is related to a modular above-ground vertical farming structure for use in an outdoor environment. The structure may include a rigid top bed; at least one rigid shaded bed; and a framework adapted for mechanical coupling to the top bed and the at least one shaded bed such that, when coupled the framework supports the top bed and the at least one shaded bed and maintains the top bed and the at least one shaded bed in vertically stacked alignment. The framework may comprise a plurality of supports. The top bed and the at least one shaded bed may each comprise a horizontal platform with a top surface surrounded by at least one wall and configured to receive, support, and/or contain a plant growing medium.

The horizontal platform of each of the top bed and the at least one shaded bed may be configured to support the load of the heavy plant growth medium of at least 200 kilograms. The dimensions of the structure may allow direct sunlight to reach the center of the bed for at least a threshold exposure time when the structure is installed on an earth surface at sea level with open sky. Structures may further include a barrier configured to prevent water percolating to underlying beds. The rigid top bed and the at least one rigid shaded bed may each comprise a flexible membrane supported by at least one of i) a lattice, and ii) webbing. The rigid top bed and the at least one rigid shaded bed may each comprise a sheeting supported by at least one of i) a lattice, and ii) webbing. When coupled, the framework may cooperate with the top bed and the at least one shaded bed to form at least two vertically stacked enclosures, wherein each enclosure comprises: a lower section configured to receive a plant growing medium, the lower section comprising a horizontal floor and a plurality of wall sections at the perimeter of the horizontal floor; and a ceiling opposing the horizontal floor; and wherein each enclosure defines a plurality of openings permitting the exchange of air within an interior space defined by the enclosure and fresh air from outside the interior space.

The structure may further comprise a plant growing light source configured to direct photosynthetically active radiation (PAR) to the at least one rigid shaded bed. The structure may further comprise a power subassembly providing power to the plant growing light source, the power subassembly including a solar panel array. The structure may further comprise a light sensor responsive to incident light at the structure and providing measurements indicative of photosynthetically active radiation (PAR) on the shaded bed; a plant growing light source; a power subassembly; and a controller configured to direct the plant growing light source to provide additional photosynthetically active radiation (PAR) to the at least one rigid shaded bed in dependence upon the measurements.

In other aspects, the present disclosure is directed to stackable above-ground vertical farming units for use in an outdoor environment. The stackable units may include a bed section comprising a rigid platform and two opposed side walls and two opposed end walls coupled to the platform; and at least four vertical leg members coupled to the bed section. At least one of i) the two opposed side walls, and ii) the two opposed end walls may each comprise a bottom flange which extends inwardly of the bed section. The bottom flanges may each comprise ports receiving proximal ends of the at least four vertical leg members. The rigid platform may comprise a flexible membrane supported by at least one of i) a lattice, and ii) webbing. The rigid platform may comprise a sheeting supported by at least one of i) a lattice, and ii) webbing. The flexible membrane may have a thickness between about 0.3 mm and about 7 mm. The flexible membrane may comprise at least one of rubber, plastic, Teflon, low density polyethylene, high density polyethylene, polypropylene, nylon, polystyrene, polycarbonate, polyethylene terephthalate, polyamides, PVC, acrylic, and composites. The rigid platform may comprise at least one of i) a lattice, and ii) a honeycomb panel.

The stackable units may include a bed section configured to receive a heavy plant growing medium and comprising a rigid platform and two opposed side walls and two opposed end walls coupled to the platform; and at least four vertical leg members coupled to the bed section. At least one of i) the two opposed side walls, and ii) the two opposed end walls may each comprise a bottom flange which extends inwardly of the bed section. The bottom flanges may each comprise ports receiving proximal ends of the at least four vertical leg members. The rigid platform may comprise a flexible membrane supported by at least one of i) a lattice, and ii) webbing. The rigid platform may comprise a sheeting supported by at least one of i) a lattice, and ii) webbing. The flexible membrane may have a thickness between about 0.3 mm and about 7 mm. The flexible membrane may comprise at least one of rubber, plastic, Teflon, low density polyethylene, high density polyethylene, polypropylene, nylon, polystyrene, polycarbonate, polyethylene terephthalate, polyamides, PVC, acrylic, and composites. The rigid platform may comprise at least one of i) a lattice, and ii) a honeycomb panel.

In aspects, the present disclosure is related to methods for constructing a farming system including assembling an above-ground vertical farming structure in an outdoor environment. Assembling the above-ground vertical farming structure in an outdoor environment may be carried out by placing a foundational bed in a horizontal orientation; coupling each of a plurality of elongated support members to the foundational bed in a vertical orientation; engaging a biasing member with each of the plurality of elongated support members at a threshold vertical distance above the foundational bed; coupling an elevated bed with the biasing members engaged with each of the plurality of elongated support members to complete the above-ground vertical farming structure; and adding a heavy plant growth medium to the elevated bed. The above-ground farming structure may include at least one shaded bed comprising the foundational bed and a top bed comprising the elevated bed. The top bed and the at least one shaded bed may be in vertically stacked alignment. The foundational bed may be placed in a horizontal orientation substantially flat on a substantially planar outdoor surface. Methods may include assembling a plurality of above-ground vertical farming structures arranged in a plurality of rows separated by aisles having dimensions sufficient for heavy lift equipment. Methods may include paving the aisles. In some aspects, adding the growth medium to the elevated bed is carried out prior to coupling the elevated bed with the biasing members. Adding the heavy plant growth medium to the elevated bed may comprise adding at least 200 kilograms of heavy plant growth medium to the elevated bed.

Structures may further include an adjustable reservoir configured to prevent water percolating to underlying beds. The reservoir may comprise a container including raised sides. Structures may be configured to enable movement of water from the reservoir into the soil above the bed through capillary processes in the soil. Structures may define a gap between the framework and at least a portion of the walls of at least one off the beds upon assembly of the structure to allow an upper end of the reservoir to surround a lower end of the bed, e.g., proximate the floor of the bed. Fittings in the reservoir and the framework may enable the reservoir to be fastened to the framework in the appropriate configuration. Alternatively, the reservoir may be fastened to the bed.

The reservoir may be detachably coupled to either the framework or bed so to allow substitution of smaller or larger reservoirs as needed, or to remove the reservoir completely if conditions dictate. Reservoirs may be different sizes to contain more or less water. The fittings may allow for attachment of the reservoir at a higher or lower position with respect to the bed. Thus, the levels at which the beds are held can be adjusted as needed. Coupling mechanisms may enable raising the reservoir as the water level in the reservoir drops and loses surface contact with the soil in the bed.

Aspects of the present disclosure may include above-ground vertical farming systems for installation on a surface in an outdoor environment. Systems may comprise a structure including i) a bed comprising a horizontal platform at a lower end of the bed and ii) a framework coupled to the bed and configured to maintain the bed in a position elevated from a surface while the framework is in contact with the surface, wherein the platform comprises a floor surrounded by at least one wall and the bed comprises at least one flowpath configured to allow drainage of water from the lower end of the bed; and a reservoir positioned with respect to the structure with an upper end of the reservoir surrounding at least a portion of the lower end of the bed proximate the floor of the bed and a lower end of the reservoir positioned at a point lower than the bed.

Systems may be configured to introduce water from the reservoir to the growth medium when the reservoir is filled with a threshold volume of water. Systems may be configured to introduce water from the reservoir to the growth medium via capillary processes. The at least one flowpath may comprise at least one of: i) a conduit, ii) a port defined by at least one surface of the bed, iii) a capillary hole defined by at least one surface of the bed, iv) a capillary slot defined by at least one surface of the bed, and iv) a water permeable material. The structure may be configured to enable movement of water from the reservoir into the growth medium received in the bed through capillary processes. The structure may be configured to support a load of a heavy growth medium received in the bed. The reservoir may be coupled to the framework or to the bed. The reservoir may comprise a container including raised sides and a plurality of substantially vertically oriented poles supporting the container in an elevated position with respect to the structure with the upper end of the reservoir surrounding at least the portion of the lower end of the bed proximate the floor of the bed and the lower end of the reservoir positioned at the point lower than the bed. The structure may define a gap between the framework and at least a portion of the at least one wall sufficient to allow an upper end of the reservoir to be positioned between the framework and the portion of the at least one wall while surrounding the lower end of the bed proximate the floor of the bed.

Aspects of the present disclosure may include an above-ground vertical farming apparatus for attachment to a bed comprising a horizontal platform at a lower end of the bed, the platform comprising a floor surrounded by at least one wall, the bed elevated from a surface in an outdoor environment. The apparatus may comprise a reservoir comprising an alignment means to align the reservoir elevated from the surface with an upper end of the reservoir surrounding at least a portion of the lower end of the bed proximate the floor of the bed and a lower end of the reservoir positioned at a point lower than the bed. The apparatus may further comprise a framework adapted for connection to the bed and configured to maintain the bed in a position elevated from the surface while the framework is in contact with the surface.

Aspects of the present disclosure may include a modular above-ground vertical farming structure for use in an outdoor environment, comprising: a rigid top bed; at least one rigid shaded bed; and a framework adapted for mechanical coupling to the top bed and the at least one shaded bed such that, when coupled, the framework supports the top bed and the at least one shaded bed and maintains the top bed and the at least one shaded bed in vertically stacked alignment, the framework comprising a plurality of supports. The top bed and the at least one shaded bed may each comprise a horizontal platform with a top surface surrounded by at least one wall and configured to support a load of a heavy plant growth medium received in each of the top bed and the at least one shaded bed. The structure may include a reservoir coupled to the structure and configured to prevent water percolating from the rigid top bed to the at least one rigid shaded bed. The structure may be configured to introduce water from the reservoir to the growth medium when the growth medium is in the bed and the reservoir is filled with a threshold volume of water. The structure may be configured to introduce water from the reservoir to the growth medium via capillary processes.

Examples of some features of the disclosure may be summarized rather broadly herein in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIGS. 1A-1C illustrate modular above-ground vertical farming structures for use in an outdoor environment in accordance with embodiments of the present disclosure;

FIGS. 2A-2E illustrate alternative mechanical coupling implementations for a modular above-ground vertical farming structure in accordance with embodiments of the present disclosure;

FIGS. 3A & 3B illustrate alternative above-ground vertical farming structures for use in an outdoor environment in accordance with embodiments of the present disclosure;

FIGS. 4A & 4B show a solar lighting diagram for an above-ground vertical farming structure for use in an outdoor environment in accordance with embodiments of the present disclosure;

FIGS. 5A & 5B shows an alternative modular above-ground vertical farming structure for use in an outdoor environment in accordance with embodiments of the present disclosure;

FIG. 5C shows a cross-sectional view of retaining bracket in accordance with embodiments of the present disclosure;

FIGS. 6A & 6B show support structures for rigid platforms for use in an above-ground vertical farming structure in an outdoor environment in accordance with embodiments of the present disclosure;

FIG. 7 illustrates methods for constructing a farming system in in accordance with embodiments of the present disclosure; and

FIG. 8A-8D illustrates alternative above-ground vertical farming structures in accordance with embodiments of the present disclosure;

FIGS. 9A-9D illustrate alternative flowpaths facilitating capillary action to reintroduce water into the growth medium from the reservoir in accordance with embodiments of the present disclosure; and

FIG. 10A-10C illustrate alternative above-ground vertical farming systems in accordance with embodiments of the present disclosure.

### DETAILED DESCRIPTION

Aspects of the present disclosure relate to agricultural equipment and more particularly to above-ground vertical farming structures for use in an outdoor environment. In particular, aspects of the disclosure are related to structures implementing vertically stacked raised beds configured for the growing of plants outdoors.

Producing sufficient food for growing populations with minimal increase on humanity's agricultural footprint is among the major challenges of the 21st century. Of the projected human population of 9.7 billion by 2050, seven out of ten people will live in cities. Currently, urban dwellers consume most of the food. Thus, urban farming is a critical component of future global food system production.

Urban farming can contribute towards food security, food system resilience, and sustainability. Interest in use of roof tops and gray areas in cities to raise crops is increasing. It is estimated that up to ten percent of globally produced legumes, vegetables, and tubers are produced in urban agriculture currently. However, the limited availability of land caps the size of most urban food production operations, which hampers efforts for commercial profitability. Limited spaces can also preclude urban dwellers from participating in urban agriculture. Even in rural settings, many potential farmers are precluded from commercial viability due to plot size. Many rural plots are less than two acres. Aspects of the present disclosure expand the production capacity of a limited agricultural space by providing a robust vertically stacked raised bed system to increase the growing area in a given amount of available land surface area in an environment, or “footprint.”

Previous solutions to multi-level growing have proven ineffective for outdoor conditions. Vertically stacked beds accommodate the greatest possible number of beds in an enclosed area, whether in an urban or rural setting. However, previous vertical gardening arrangements cannot be scaled appropriately for agriculture on an industrial scale.

Sufficient height between beds and spacing between plants is necessary to allow air movement required to prevent the spread of disease and insects. To support crop production on a commercially viable scale, the raised beds not in contact with the ground must provide sufficient surface area and soil depth for the crops grown in commercial agriculture, and as a result must support a sufficient volume of heavy growing medium, such as soil, compost, or a combination of the two. That is, in aspects of the present disclosure the depth of the bed, as measured from the soil fill line at the top of the bed wall to the top surface of the bed floor, is configured to match the optimal soil depth (e.g., root depth) for the fruit, berry, or vegetable grown and provide for an optimal number of plantings in a bed.

For example, 15 centimeters to 45 centimeters of soil depth may be optimal for crop production, with each plant requiring 25 to 25,000 square centimeters of allocated bed surface, depending on the crop. Thus, a commercial bed may have a minimum depth of at least fifteen centimeters, and a length and width of at least 125 centimeters. An ideal bed may have a depth of at least fifteen centimeters, a width of at least two meters, and a length of two meters or longer. A cubic yard of topsoil typically covers about 9-10 square meters to a depth of 7.5 centimeters. A cubic yard of loose, dry topsoil typically weighs almost 1,000 kilograms. When wet, soil can weigh 40 to 50 percent more. Thus, at minimum, a commercially viable bed in a vertically stacked bed structure in accordance with aspects of the present disclosure may be configured to support at least 200 kilograms of growing medium and will have greater than 1.5 square meters in surface area for the bed, while supporting the bed above the ground. These significant engineering challenges in scaling up vertically stacked raised bed structures to sufficient size while providing optimal structural stability to support the requisite soil volume are addressed and overcome in embodiments described below.

A further challenge is providing sufficient light for crop growth with one or more beds in the vertically stacked bed structure being a bed blocked from direct sunlight from directly overhead by one or more beds above it (“shaded beds”). Specific design configurations and features to solve this challenge are described below with respect to specific embodiments. The innovations embodied by methods, apparatus, and systems of the present disclosure are a substantial improvement over the prior art.

To prevent any possible confusion, it is noted here that terraced raised beds do not expand the growing area in a given footprint, and thus, despite sometimes being referred to as “stacked beds”, are differentiated from stacked beds as referred to herein. Likewise, in the context of outdoor farming, the term “vertical farming” may be employed to describe terraced farming. Because these terraced beds provide the same total area for crop production as single layer raised beds, they provide no improvements in efficiency over an ordinary single raised bed.

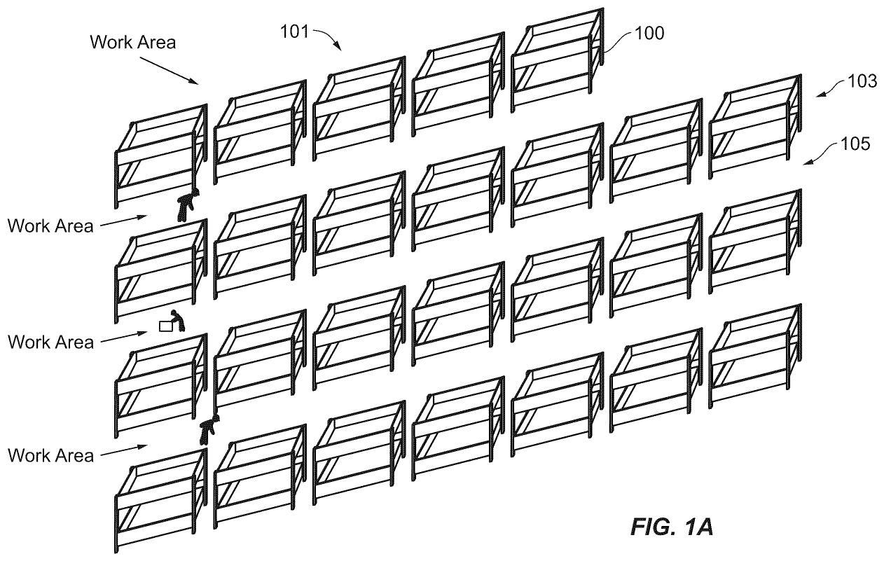

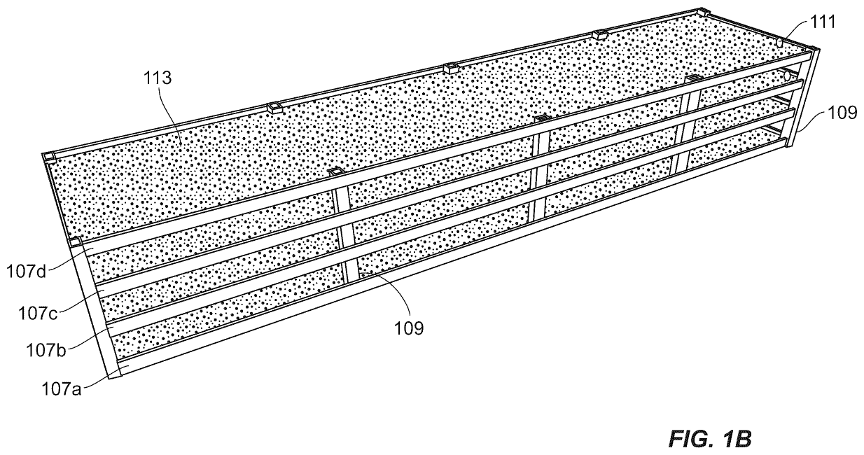

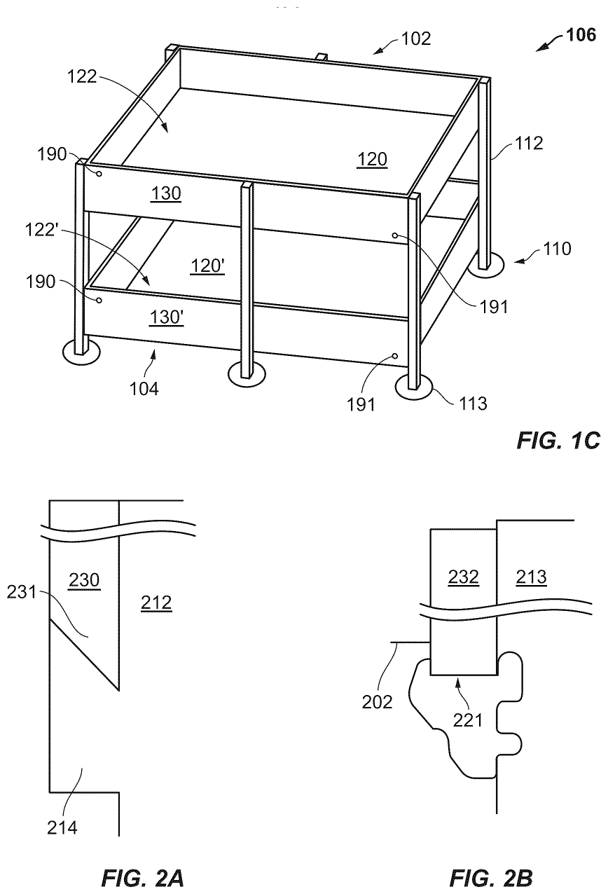

FIGS. 1A-1C illustrate modular above-ground vertical farming structures for use in an outdoor environment in accordance with embodiments of the present disclosure. FIG. 1A shows a farming system for use in an outdoor environment employing above-ground vertical farming structures in accordance with embodiments of the present disclosure. Stacked beds 100 are arranged on an acre of land to achieve a production area approaching two or more traditionally farmed acres. If additional layers are introduced, the total production area could be further multiplied over a traditionally farmed plot. In one section 101 of the farm, vertically stacked beds 100 are arranged in rows 103 with aisles 105 in between the rows. Aisles 105 may be wide enough to accommodate the movement of needed farm tools and equipment such as jacks, forklifts, and/or reach trucks (collectively, “heavy lift equipment”) and may be paved with gravel, decomposed granite, asphalt, cement, concrete, or other paving. Alternatively, section 101 may be located on reclaimed parking areas or razed land. The number of beds in a stack and the space between beds may be variable.

Structure 100, shown assembled in FIG. 1B, comprises a number of vertically stacked beds 107a-107d, including a foundational bed 107a which lies substantially flat on a substantially planar outdoor surface (e.g., an earth surface or rooftop). The stacked beds include rigid shaded beds 107a-107c and rigid top bed 107d. In assembling the structure, the foundational bed 107a may be coupled to vertical supports 109. Vertical supports may be sunk into the earth and optionally incorporated into a poured concrete structure such as a footer, pier, or caisson (not shown). Elevated beds 107b, 107c, and 107d may be added in sequence and coupled to the vertical supports 109. The elevated beds may be lifted into place by hand or with the use of heavy machinery. Soil or other plant growing media may be added to the beds before or after installation and coupling. Biasing members (e.g., brackets, ledges, or the like) may be added in sequence to vertical supports to engage a corresponding bed. Beds may have ports or sleeves to allow journalling of the supports. Beds may include a horizontal platform, described in further detail below with respect to FIG. 1C, comprising permeable or semi-permeable material facilitating drainage. Beds may also include drainage ports 111 and may be configured to provide one or more sloped lower surfaces to the bed for drainage.

The lowermost bed may be elevated, so that a gap exists between the underside of the lowest bed and the ground. Structure 106, shown assembled in FIG. 1C, comprises a rigid top bed 102, a rigid shaded bed 104, and framework 110. Framework 110 is shown coupled to the top bed 102 and the shaded bed 104 to support the top bed and the shaded bed. Framework 110 includes supports 112 mechanically coupled to the rigid top bed 102 and the rigid shaded bed 104. Supports 112 may hold the shaded bed 104 off the ground. Supports 112 may be made of steel, aluminum, composite material, and the like. Supports 112 may include feet 113 at a lower end or be imbedded into the earth surface for stability or where the bed is in direct contact with the soil. Framework 110 maintains the top bed 102 and the shaded bed 104 in vertically stacked alignment.

The top bed and the shaded bed each comprise a horizontal platform 120, 120′ with a top surface 122, 122′ surrounded by walls 130, 130′. The top bed 102 and the shaded bed 104 are configured to receive, support, and contain a heavy plant growing medium, such as soil or compost. As described above, horizontal platform 120, 120′ may be permeable. In other embodiments, horizontal platform 120, 120′ may also include an impermeable barrier so that the water is contained in the stacked bed. Walls 130, 130′ may include ports to allow water to drain. A upper port 190 may be positioned in one or more of walls 130, 130′ at or slightly above the intended soil line to drain water that could potentially overfill the stacked bed during heavy water events, such as rainstorms. Alternate embodiments may include a plurality of upper ports at different heights from the floor of the bed, with each port having a sealing means such as a tap, plug, or threaded cap, so that the drain height is adjustable. A lower port 191 may be positioned in one or more of walls 130, 130′ proximate the floor of the bed, to prevent oversaturation of the bed with water which can be detrimental for plant growth. Waterlogged soil conditions result in hypoxia or anoxia, creating an anaerobic environment which can effectively kill the plants. The lower port 191 may also be fitted with a sealing means such as a tap, plug, or threaded cap to allow selective flow of water from the port. The upper ports 190 (‘escape outlet’) and/or lower ports 191 may be fitted with a conduit such as a pipe or hose to drain water to a desired location (e.g., a rain barrel) away from the rest of the stacked beds to prevent contamination. For example, the lower port may be sealed with a tap featuring a simple two-way valve to release water if the stacked bed is saturated, with a hose pipe fitted to the tap to drain the water away from the structure to avoid contaminating other beds. Each of the stacked beds could have this configuration. In other conditions or with particular crop variations, ports 190 and 191 may be detrimental, and may be omitted.

In other embodiments, supports 112 may be longer so that the number of vertically stacked shaded beds is increased. Beds may also be further elongated to increase capacity. Supports 112, 112′ may be attached to the beds 102 and 104 via clevis pins, threaded fasteners, or the like. Beds may be vertically spaced 25 to 150 centimeters apart depending on the crop. In one example, beds are spaced 50 centimeters apart.

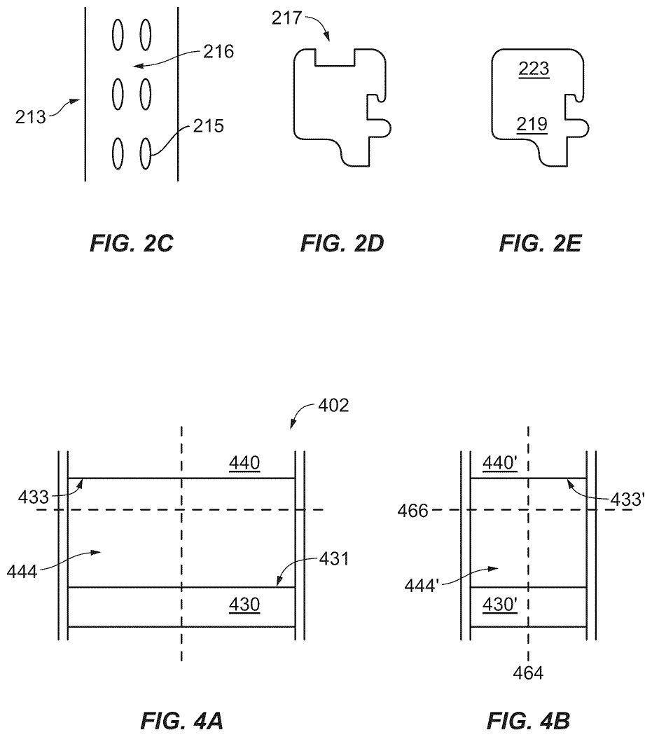

FIGS. 2A-2D illustrate alternative mechanical coupling implementations for a modular above-ground vertical farming structure in accordance with embodiments of the present disclosure. Beds may be coupled to supports via biasing members, which may be incorporated in the support or separate. In FIG. 2A, support 212 includes cleat 214. Wall 230 protrudes below the platform and includes a lower edge 231 adapted to engage cleat 214.

A biasing member may be engaged with each of the plurality of elongated support members at a threshold vertical distance above the foundational bed. In turn, an elevated bed may be coupled with the biasing members engaged in support members. FIGS. 2B-2D illustrate a standard and bracket coupling. From the view of the attachment face 216, support 213 includes slots 215 which extend through support 213 or to the interior of support 213, if support 213 is tubular. Bracket 217 is configured to engage slots 215. Once engaged with a slot, bracket 217 may be engaged by the bed by lowering wall 232 onto the bracket in rest 221. Other biasing members include non-supporting bracket 219 with horizontal movement constraint flange 223. By placing the attachment means (e.g., cleats or slots) at regular small intervals (e.g., every 5 centimeters, 10 centimeters, etc.), the vertical location of the bed levels may be dynamic with the spaces between the deck levels adjustable depending on the intended crops and the available sunlight, as described in further detail below.

In some conditions, water percolates through the growth medium of an installed bed to reach the upper surface of the horizontal platform. As described above, beds in FIG. 1B, as installed, may facilitate percolation of water through the upper bed and the platform to reach a lower bed. This is particularly so during watering and more so during rainstorms. In particular conditions, this percolation advantageously makes efficient use of water (reducing potential water loss) and reduces labor and/or infrastructure needed to sufficiently water all portions of the growth medium in the structure.

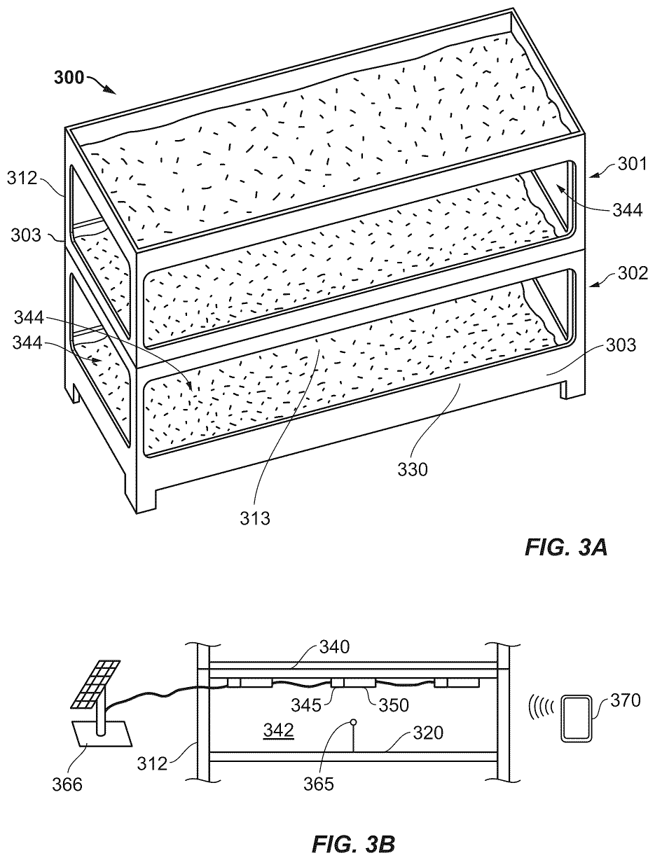

As described with respect to FIG. 1C, in some conditions, transmission of water from one bed to another is detrimental. Water from the upper beds may be unclean and may contaminate crops proximate harvest time. This may be especially true for leafy vegetables such as lettuce, which may be consumed raw (e.g., in salads). Conversely, oversaturation may also impede crop health. In these conditions, a barrier may be inserted between the beds to prevent water from percolating from the upper beds to beds below. The barrier could be placed at a distance from the lower bed so as to not interfere with the growth of crops in the lower bed. The barrier may comprise a metal sheet, impermeable plastic or composite material, or wood. In other embodiments, the barrier may be placed directly in contact with the stacked bed. In this case the water may be contained in the stacked bed. FIGS. 3A & 3B illustrate alternative above-ground vertical farming systems for use in an outdoor environment in accordance with embodiments of the present disclosure. System 300 comprises two vertically stacked enclosures, 301 and 302. Each enclosure 301, 302 comprises a lower section 303 configured to receive a heavy plant growing medium 313. The lower section comprises a horizontal floor 320 and a plurality of wall sections 330 at the perimeter of the horizontal floor 320. Each enclosure 301, 302 includes a ceiling 340 opposing the horizontal floor. Each enclosure 301, 302 also includes supports 312 connecting the ceiling and the lower section. Each enclosure defines a plurality of openings 344 permitting the exchange of air within an interior space 342 defined by the enclosure and fresh air from outside the interior space. The spacing may be from 25 to 200 centimeters, and the width of the stacked beds may be from 50 to 250 centimeters or more. Length of the beds may vary from two meters to ten meters or longer. In one example, beds are spaced 50 centimeters apart and may be 200 centimeters wide.

As described above, one challenge prohibiting the use of vertically stacked beds is providing sufficient light for crop growth to the one or more shaded beds in the vertically stacked bed structure blocked from direct sunlight from overhead (e.g., when the sun is at its zenith). The openings of system 300 are configured to allow significant light penetration from the sun above a threshold zenith angle, as described in more detail below with reference to FIGS. 4A & 4B. System 300 also includes a plant growing light source 350, solar panel array 366, light sensor 365, and controller 345, which cooperate to provide supplementary light if the daily light exposure fails to meet a threshold for the crops planted in the bed.

Plant growing light source 350, such as, for example, one or more light emitting diode (LED) lamps, may be used to supplement sunlight depending on the DLI of the bed on a given day, or other sunlight measurement, such that a minimum daily light exposure is met. Light sensor 365 (e.g., quantum flux sensors) mounted in the structure may be used to take insolation measurements, which are input to controller 345 via a wired or wireless connection.

Plants are most sensitive to light within the visible spectrum. Therefore, light that falls into this usable range of wavelengths between 400 nanometers and 700 nanometers is called photosynthetically active radiation (PAR). A plant growing light source 350, such as, for example, one or more light emitting diode (LED) lamps configured to emit light at wavelengths between 400 nanometers and 700 nanometers, may be installed at the ceiling 340 to provide light to plants growing in the growth medium in the lower section below it. This light source may be powered by photovoltaic energy from solar panel array 366 located nearby.

Controller 345 may control plant growing light source 350, solar array 366, and/or light sensor 365 by sending command messages or through analog control circuitry. Controller 345 may include logic implemented in an information processing device to determine the timing, intensity, and/or wavelengths of supplemented light from light source 350 to meet the minimum daily light exposure.

A control device 370, such as a dedicated control device, tablet, mobile telephone, other smart device, or the like, may be intermittently or continuously connected to controller 345 via wired or wireless communication, and be used to update algorithms for determining the timing, intensity, and/or wavelengths of supplemented light from light source 350 or to change parameter values used in these algorithms. For example, a smart phone running a control application may be connected to controller 345 via Bluetooth or USB. The control application may receive a log file including real-time and/or historical measurements from light sensor 365 and real-time and/or historical parameter values and render a presentation based on these values on the smart phone display. The user may use an application interface to change the minimum daily light exposure, set minimum or maximum values on timing, intensity, and/or wavelengths of supplemented light, and so on.

FIG. 4 shows a solar lighting diagram for an above-ground vertical farming structure for use in an outdoor environment in accordance with embodiments of the present disclosure. The dimensions of the plurality of openings 444, 444′ between corresponding lower outer edges 433, 433′ of an upper bed 440, 440′ and upper outer edges 431, 431′ of a lower bed 430, 430′ may be configured to allow direct sunlight to reach the center of the bed for at least a threshold exposure time during a growing period when the structure is installed on an earth surface at sea level at forty degrees latitude with open sky. The term “open sky” refers to conditions where no obstructions (including ground slope, vegetation, or intervening topography) interrupt insolation of an object.

The threshold exposure time may be determined in relation to the amount of sunlight required to grow a large number of plants at a particular longitude, and may be for example, 3 hours, 3.5 hours, 4 hours, 6 hours, 8 hours and so on. The dimensions of the plurality of openings 444, 444′ may be configured to allow direct sunlight to reach the center of the bed for at least a threshold exposure time during a growing period when the structure is installed on an earth surface at sea level at a target latitude with open sky. Alternatively, the dimensions of the plurality of openings may be configured to allow direct sunlight to reach an intersection of a central longitudinal plane 464 of the bed and a maximum optimal growth height 466 above the horizontal floor for at least for at least a threshold bed exposure time during a growing period when the structure is installed on an earth surface at sea level with open sky.

The dimensions of the plurality of openings may be configured to allow direct sunlight through the openings, during a growing period when the structure is installed on an earth surface at sea level with open sky, producing a threshold Daily Light Integral (DLI). The threshold Daily Light Integral (DLI) may be determined in relation to the amount of sunlight required to grow a large variety of plants at a target latitude. Example threshold DLI may include, for example, of at least 5 moles per square meter per day, 8 moles per square meter per day, 10 moles per square meter per day, 15 moles per square meter per day, 20 moles per square meter per day 25 moles per square meter per day, 30 moles per square meter per day, and so on.

The target latitude may be 40 degrees, a latitude between 35 and 45 degrees, a latitude between 30 and 50 degrees, a latitude between 35 and 50 degrees, and so on. In some examples, markings may be supplied on the supports indicative of bed or bracket placement for a threshold DLI, a type of plant, a particular latitude, a particular threshold exposure time at a given latitude, combinations of latitude and exposure time, and so on.

Aspects of the disclosure include storage of optimal bracket placement or dimensions for particular combinations of any of type of plant, latitude, threshold DLI, threshold exposure time, and so on in a lookup table in storage accessible to a server. The server may be configured to respond to requests from a web browser providing any of type of plant, latitude, threshold DLI, threshold exposure time, and so on with optimal bracket placement or dimensions for structures as described herein.

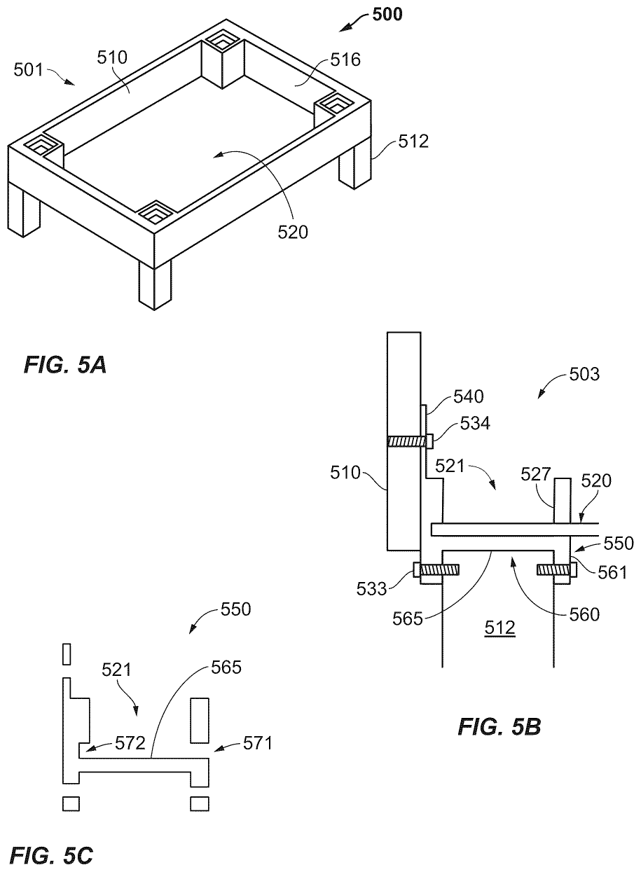

FIGS. 5A & 5B show alternative modular above-ground vertical farming structures for use in an outdoor environment in accordance with embodiments of the present disclosure. Structure 500 comprises a stackable above-ground vertical farming unit. Referring to FIG. 5A, structure 500 comprises a bed section 501 comprising a rigid platform 520. Structures 500 are rectangular stackable to maximize the growing space in a given footprint. Each bed section 501 comprises two opposed side walls 510 and two opposed end walls 516 coupled to the platform 520. Structure 500 also includes four vertical leg members 512 coupled to the bed section. The bed section or portions thereof (e.g., walls, platform, etc.) may be molded from thermoplastic or may comprise wood, composites, vinyl, folded metal, plate steel, or the like, or may comprise a shell of the same with a filler material interior to the shell. The leg members 512 may be attached via a “snap-in” mechanism, or may be attached via fasteners or friction fit. The weight of the soil may also help keep the bed in place

In other implementations the opposed side walls and the opposed end walls may be coupled together via threaded fasteners. For example, end walls may feature a plurality of longitudinal bores with counterbores at each end. A partially or entirely threaded rod may be inserted through the bores and held at each end. These same rods may also provide support for rigid platform 520. In some implementations opposing walls may comprise panels having a bottom flange which extends inwardly of the bed section. The flange may extend along the edge of the wall and be connected with the rigid platform, such as, for example, by threaded fasteners. Mortise and tenon joints may also be employed where end walls and sidewalls intersect. In other implementations the opposed side walls and the opposed end walls may be coupled together through angled supports.

FIG. 5B shows a cross-sectional view of a corner of another modular above-ground vertical farming structure for use in an outdoor environment in accordance with embodiments of the present disclosure. Structure 503 features retaining brackets 550 which are aligned at the corners of the bed section and engaged to provide additional structural reinforcement to ensure structural integrity at the joints. FIG. 5C shows a cross-sectional view of retaining bracket 550. Retaining bracket 550 comprises a pocket 560 for receiving supports 512 formed by sides 561 and a lower surface of floor plate 565. Two backplates 540 meet at a corner of the bracket.

Referring to FIGS. 5B & 5C, retaining bracket 550 further comprises a nest 521 opposite pocket 560 for receiving the distal end of a vertical leg member 512 of a second structure stacked vertically with structure 503. Nest 521 includes collar wall 527 and the upper surface of floor plate 565. Bracket 550 defines a gap 572 between collar wall 527 and floor plate 565 which is aligned with slot 571. Slot 571 is configured to receive rigid platform 520 such that, after assembly, a leg member 512 may rest on a portion of the rigid platform when inserted into pocket 560. After receiving rigid platform 520 in slot 571, side wall 510′ and end wall 516′ may be aligned flush with respective backplates 540, optionally coupled together, and coupled to backplates on the respective side via threaded fastener 534 to form bed section 520′. Vertical leg members 512 may then be inserted into pocket 560 and coupled to the bed section 520′ by threaded fasteners 533. As described above, the opposed side walls and the opposed end walls may each comprise a bottom flange which extend inwardly of the bed section. These bottom flanges may include ports receiving proximal ends of the at least four vertical leg members 512. The rigid platform 520 may rest upon and be coupled with the flanges (e.g., through threaded fasteners).

Rigid platform 520 may comprise solid steel, aluminum, vinyl, plastic, polymer, fiberglass, or composite sheeting or planks, or may be formed from a top member over a support structure. The support structure may comprise stiff honeycomb material sandwiched between sheet material adhered to the honeycomb. The top member may be a flexible membrane or sheeting as described above. The flexible membrane may comprise at least one of rubber, plastic, Teflon, low density polyethylene, high density polyethylene, polypropylene, nylon, polystyrene, polycarbonate, polyethylene terephthalate, polyamides, PVC, acrylic, and composites, or combinations of these. The flexible membrane may have a thickness between about 0.3 mm and about 7 mm.

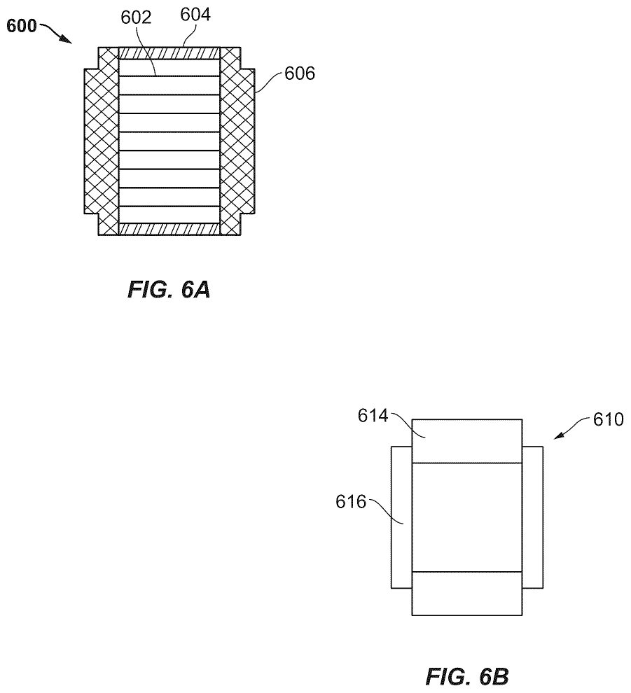

FIGS. 6A & 6B show support structures for rigid platforms for use in an above-ground vertical farming structure in an outdoor environment in accordance with embodiments of the present disclosure. In FIG. 6A, support structure 600 comprises a crosspiece 604 spanning a pair of longitudinal planks 606 at each end and struts 602 coupling longitudinal planks 606. Struts 602 may be coupled under tension. Struts 602 may alternatively be replaced by or reinforced with a lattice (e.g., steel, composite, etc.) or webbing (e.g., nylon, steel cable, etc.). In FIG. 6B, support structure 610 comprises a pair of horizontal beams 614 spanning a pair of longitudinal beams 616 at each end.

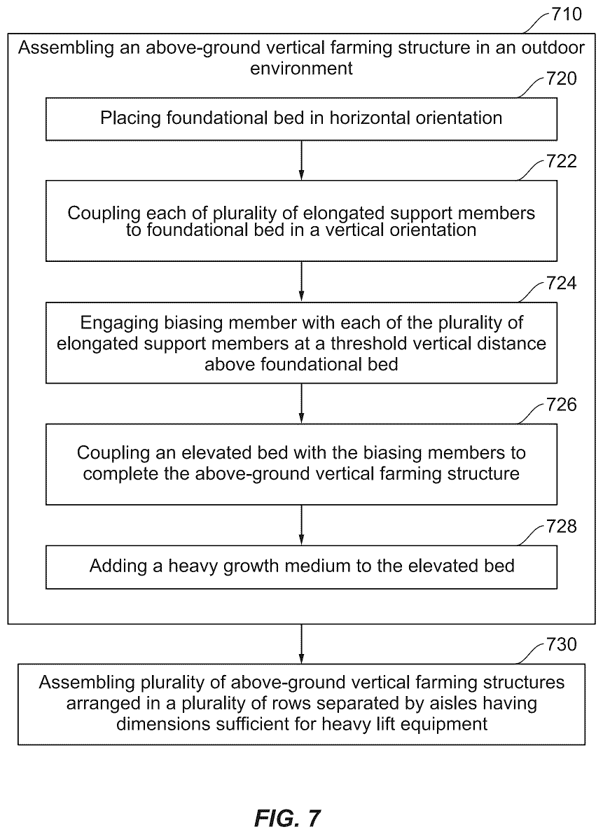

FIG. 7 illustrates methods for constructing a farming system in in accordance with embodiments of the present disclosure. Method 700 includes assembling an above-ground vertical farming structure in an outdoor environment (step 710). Step 710 may include step 720, placing a foundational bed in a horizontal orientation. Step 710 may include step 722, coupling each of a plurality of elongated support members to the foundational bed in a vertical orientation. Step 710 may include step 724, engaging a biasing member with each of the plurality of elongated support members at a threshold vertical distance above the foundational bed. Step 710 may include step 726, coupling an elevated bed with the biasing members engaged with each of the plurality of elongated support members to complete the above-ground vertical farming structure. The above-ground farming structure may include at least one shaded bed comprising the foundational bed and a top bed comprising the elevated bed. The top bed and the at least one shaded bed may be in vertically stacked alignment. Step 710 may include step 728, adding a heavy growth medium to the elevated bed. Adding the growth medium to the elevated bed is carried out prior to coupling the elevated bed with the biasing members. Method 700 may include assembling a plurality of above-ground vertical farming structures arranged in a plurality of rows separated by aisles having dimensions sufficient for heavy lift equipment (step 730).

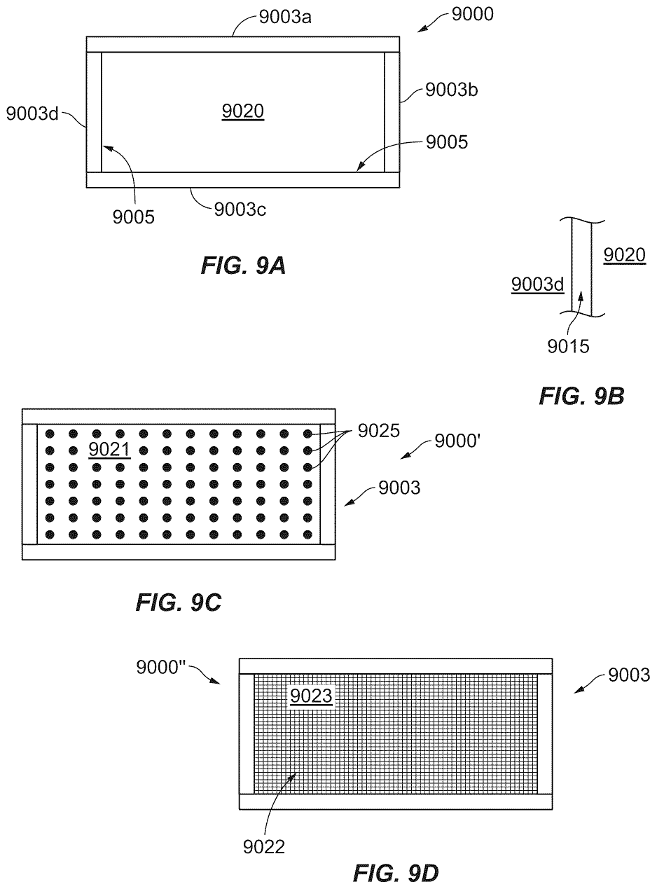

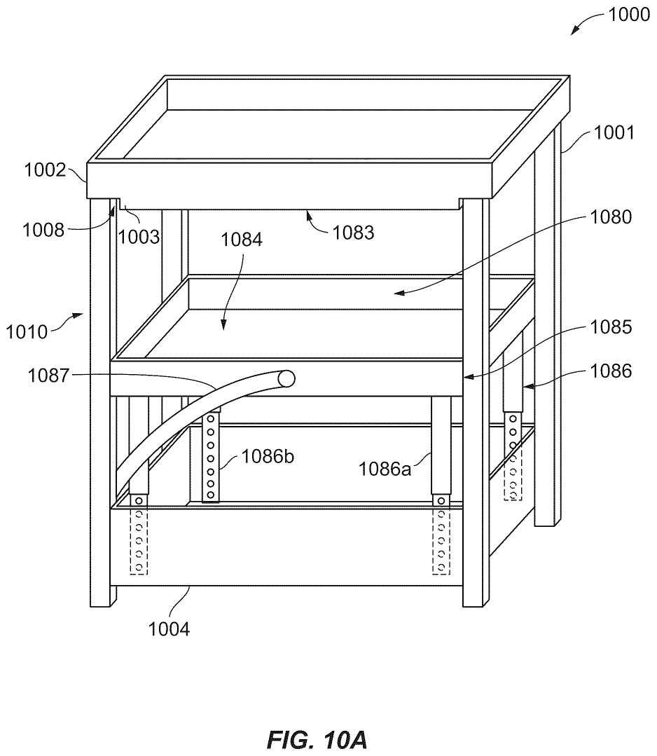

In conventional farming, beds sit on the ground and are thus connected to a large soil volume which conserves soil moisture. The stacked raised beds described herein necessarily have a shallower volume of soil (or other growth medium) compared to beds connected to the natural soil. Beds may include a platform comprising a floor surrounded by at least one wall, as described above. The beds may comprise at least one flowpath configured to allow drainage of water from the lower end of the bed, as described in further detail with reference to FIG. 9. These conditions may allow water to pass through the growing medium too quickly during watering as well as rendering the medium in the beds prone to drying, especially in hot summers. Structures may further include an adjustable reservoir positioned between the beds and configured to prevent water percolating through the growth medium in an overlying bed and reaching the growth medium in underlying beds.

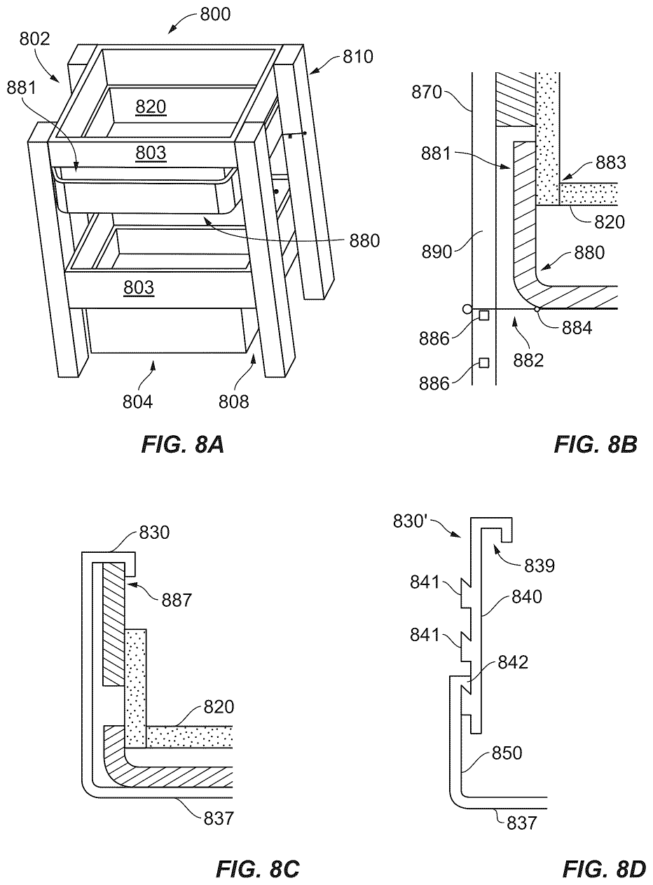

FIG. 8A illustrates alternative above-ground vertical farming structures in accordance with embodiments of the present disclosure. Structure 800, comprises a rigid top bed 802, a rigid shaded bed 804, and framework 810 maintaining the top bed 802 and the shaded bed 804 in vertically stacked alignment. Structure 800 further includes an adjustable reservoir 880 positioned between the beds and configured to prevent water percolating through the growth medium in rigid top bed 802 to rigid shaded bed 804. The reservoir 880 comprises a container including raised sides which retains water for further use.

Structure 800 is further configured to enable movement of water from the reservoir into the soil above the bed through capillary processes. By coupling the reservoir to the structure with an upper end of the reservoir surrounding at least a portion of the lower end of the bed proximate the floor of the bed, when the reservoir becomes filled with water to a threshold level, capillary processes introduce water from the reservoir to the growth medium (e.g., soil) where capillary action draws the water to spread throughout the growth medium in the bed. These processes make efficient use of water that would otherwise pass from the upper beds and be lost. Further embodiments may omit the shaded bed, or implement one or more shaded beds elevated from the surface. Reservoirs may be implemented on shaded beds, including the lowest bed, in order to make efficient use of water, which may be reintroduced to the respective bed via capillary action.

Structure 800 includes a gap 808 between framework 810 and at least a portion of the walls 803 of at least one off the beds upon assembly of the structure to allow upper end 881 of reservoir 880 to surround the lower end 883 of the bed proximate the floor of the bed. In embodiments, an orientation of the reservoir with respect to the bed is configured to introduce water from the reservoir to the growth medium when the reservoir is filled with a threshold volume of water. The threshold volume of water may correspond to a fill level in the container. Fittings in the reservoir and the framework may enable the reservoir to be fastened to framework 810 in the appropriate configuration. Alternatively, the reservoir may be fastened to the bed in a similar fashion. In other embodiments, reservoirs may be spaced from the overlying and underlying beds to prevent contact with the beds. For example, a reservoir may be positioned under a rigid top bed at a first distance from the lowest surface of the rigid top bed and over a rigid shaded bed.

In FIG. 8B, a wireframe shelf 884 is coupled to supports 882, which are in turn hung on cleat 886 on inner face 890 of support post 870 of the framework 810. In FIG. 8C, hangers 830 are configured to hook to the top end 887 of at least some of walls 803 and support reservoir 880 from underneath. Reservoir 880 may have grooves or the like to receive elements of wireframe shelf 884 or hangers 830 to seat the reservoir. Referring to FIG. 8D, hangers 830′ may comprise upper hanging element 840 and lower supporting element 850. Cleats 841 and catches 842 of the upper hanging element 840 and lower supporting element 850 respectively are configured for detachable engagement with one another. During installation, the upper element may be hung by placing the hangers 830 of the upper elements 840 initially, followed by engaging the catches 842 of the lower element 850 with desired cleats 841 of the upper elements. Thus, the system allows adjustment of the position of the reservoir with respect to the bed to introduce water from the reservoir to the growth medium when the reservoir is filled with a threshold volume of water. Implementation of hanger 830′ with multiple cleats 841, each having a different distance from the hanger end 839 of the upper element allows for adjustment of the position of the cross member 837 (and thus the reservoir 880) with respect to the platform 820.

The reservoir may be detachably coupled to either the framework or bed so to allow substitution of smaller or larger reservoirs as needed, or to remove the reservoir completely if conditions dictate. Reservoirs may be different sizes to contain more or less water. The fittings may allow for attachment of the reservoir at a higher or lower position with respect to the bed. Some implementations may feature height adjustment means, such as screw jacks, pneumatice or hydraulic mechanisms, or screw drive, direct drive, or piezoelectric linear motion actuators. Thus, the levels at which the beds are held can be adjusted as needed. Coupling mechanisms may enable raising the reservoir as the water level in the reservoir drops and loses surface contact with the soil in the bed. The depth at which the reservoir is held can depend on several factors, such as, for example, how much water one desires to capture and the height of plants being grown.

As described above, beds as presented in varoius embodiments may comprise at least one flowpath configured to allow drainage of water from the lower end of the bed and which may also facilitate capillary action to reintroduce water into the growth medium in the bed from below.

FIGS. 9A-9D illustrate alternative flowpaths facilitating capillary action to reintroduce water into the growth medium from the reservoir. FIG. 9A shows a lower view of a bed 9000 comprising walls 9003a, 9003b, 9003c, 9003d (collectively ‘walls 9003’) surrounding platform 9020. Although walls 9003 and platform 9020 are assembled and joined in a configuration to provide a bed minimizing leakage of a growth medium desired for the bed, each interface 9005 between walls 9003 and platform 9020 is not fluid-tight, and thus a fluid flowpath exists at each interface 9005. In some implementations, walls 9003 and platform 9020 are joined using interlocking woodworking techniques, which may be assisted by bands, pins or fasteners. In other implementations, fasteners used for joining align the walls 9003 and platform 9020 to produce a flowpath comprising a capillary gap (e.g., capilary slot 9015, descreibed below) at interfaces 9005 to enhance capillary processes. In these implementations, platform 9020 may comprise wood, metal, plastic, composites or combinations of these, as described hereinabove. FIG. 9B illustrates a capillary slot 9015 between wall 9003d and platform 9020. Alternatively, portions of the joining surfaces at interface 9005 may include one or more capillary slots 9015, produced by any additive or subtractive manufacturing processes, such as, for example, milling, mitering, or molding. FIG. 9C illustrates bed 9000′ having alternative flowpaths comprising capillary holes 9025 in platform 9021. Platform 9021 may be any solid material. FIG. 9D illustrates bed 9000″ having platform 9022 comprising a permeable material sheet 9023. Permeable material sheet 9023 may comprise woven, pressed, or bonded polypropylene or polyester, burlap, and so on. Alternative flowpaths comprising capillary voids in the permeable material sheet 9023 enable capillary processes.

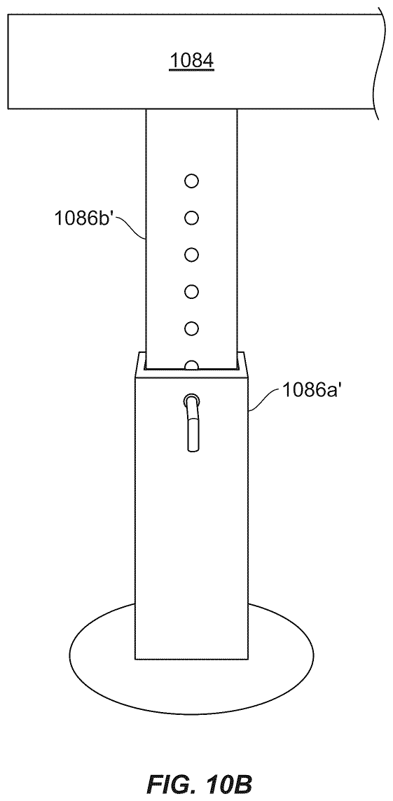

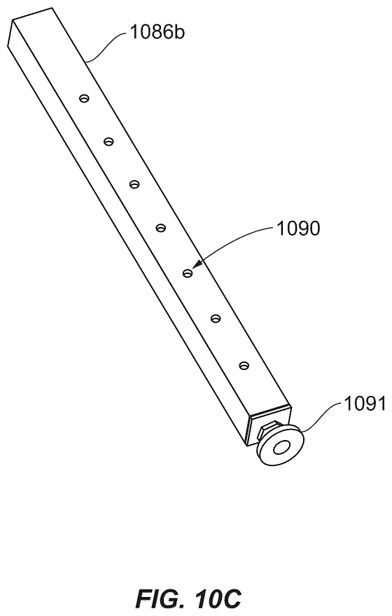

FIG. 10A illustrates alternative above-ground vertical farming systems in accordance with embodiments of the present disclosure. System 1000 includes structure 1001 comprising a rigid top bed 1002, a rigid shaded bed 1004, and framework 1010 maintaining the top bed 1002 and the shaded bed 1004 in vertically stacked alignment. Structure 1001 defines a gap 1008 between framework 1010 and at least a portion of the walls 1003 of at least one off the beds upon assembly of the structure to allow an upper end of a reservoir to surround the lower end 1083 of the bed proximate the floor of the bed.

System 1000 further includes an adjustable-height reservoir 1080 positioned between the beds and configured to prevent water percolating through the growth medium in rigid top bed 1002 to rigid shaded bed 1004. The reservoir 1080 comprises a container 1084 including raised sides 1085. A hose 1087 is connected to a port in container 1084 to allow drainage of overflow water to the ground. In alternative embodiments, container 1084 may comprise a spout incorporated in one or more walls to allow freefall gravity drainage. The reservoir 1080 further comprises four substantially vertically oriented poles 1086 supporting container 1084 in an elevated position. Reservoir 1080 is configured to allow adjustment of the reservoir height to a position enabling movement of water from the reservoir into the soil above bed 1002 through capillary processes in the soil, as described above.

Each pole is constructed of a receiving portion 1086a and an inner portion 1086b made of aluminum, steel, plastic, polymers (e.g., rigid polyvinyl chloride), or composites, or combinations thereof. The receiving portion 1086a and an inner portion 1086b may be formed of any complementary shape, but are generally tubular, e.g., having a circular, rectangular, or rounded rectangular cross section. The inner portion 1086b is sized such that it slides in and out of the receiving portion 1086a in a telescoping manner. The receiving portion may be oriented in an upper or lower position with respect to the inner portion, and either or both portions may be “lockable” at a plurality of positions with respect to one another to maintain the container at the desired elevation. As shown in FIG. 10B, for example, pole 1086′ inner portion 1086b′ is oriented in an upper position with respect to receiving portion 1086a′ and fastened to container 1084.

Returning to FIG. 10A, the receiving portion 1086a of each pole is coupled to or incorporated with container 1084. Various implementations will occur to those of skill in the art, such as manufacturing the receiving portion 1086a of each pole monolithically with container 1084 out of metal, plastic, fiberglass, composites, or other materials, such as, for example, by casting, milling, additive manufacturing, and so on. Alternatively, the receiving portion 1086a of each pole may be fastened to the container 1084 using threaded fasteners, rivets, welding, adhesives, and the like.

FIG. 10C illustrates the inner portion 1086b. The inner portion 1086b includes a plurality of holes 1090 which correspond to one or more holes 1092 of the receiving portion 1086a. While a hole 1090 and a hole 1092 of the respective pluralities are brought into alignment with the receiving portion 1086a and the inner portion 1086b in a desired position with respect to one another (resulting in a desired height for the container 1084), a pin or bolt may be inserted through the aligned holes to lock the receiving portion 1086a and the inner portion 1086b at the position. The inner portion 1086b of each leg further includes a threaded leveling mechanism 1091 at the distal end enabling a secondary height adjustment with increased granularity.

Alternatively, instead of a fully detachable pin, a locking pin mechanism may be coupled to the inner portion 1086b of each pole incoporating a push button spring clip, comprising a spring having a button pin on the end which extends through hole 1090. When the holes 1090 and 1092 are aligned, the spring causes the pin to extend through both holes 1090 and 1092 thereby locking the receiving portion 1086a and the inner portion 1086b in an extended position. To release the receiving portion 1086a and the inner portion 1086b, the button pin is pressed inwardly, thereby disengaging the pin from hole 1092. Fewer holes may be included in receiving portion 1086a and/or inner portion 1086b in this implementation.

The term “information processing device” herein includes, but is not limited to, any device that transmits, receives, manipulates, converts, calculates, modulates, transposes, carries, stores or otherwise utilizes information. An information processing device may include a microprocessor, resident memory, and peripherals for executing programmed instructions. The information processing device may execute instructions stored in computer memory accessible to a processor, or may employ logic implemented as field-programmable gate arrays (‘FPGAs’), application-specific integrated circuits (‘ASICs’), other combinatorial or sequential logic hardware, and so on. Thus, configuration of the information processing device may include operative connection with resident memory and peripherals for executing programmed instructions. In several non-limiting aspects of the disclosure, the information processing device includes a processor that executes programmed instructions for performing various methods as described above. These instructions may provide for equipment (e.g., light source) operation, data collection and analysis, and other functions. In some embodiments, carrying out methods of the disclosure may involve applying a model. The model may include, but is not limited to, (i) a mathematical equation, (ii) an algorithm, (iii) a database of associated parameters, or a combination thereof.

“Capillary processes” include capillary action and associated physical processes, including any process related to any fluid movement from a state of higher potential energy to one of lower potential energy in a non-gravitational direction, including movement related to hydraulic and hydrostatic pressures, in accordance with Darcy's Law. The driving force causing water to move between two points in soil may be expressed as a difference between the total potential at those points divided by the distance between the points. In saturated soils the driving force tends to be a result of differences in elevation and positive external pressures in the soil. In unsaturated soils, the attraction of the soil surfaces for water is often a major component to the driving force. “Capillary action” is the movement of a liquid through a narrow space (e.g., slim tube, cylinder, or permeable substance) against gravity, caused by a combination of forces from cohesion, adhesion, and surface tension.

While the foregoing disclosure is directed to the one mode embodiments of the disclosure, various modifications will be apparent to those skilled in the art. It is intended that all variations be embraced by the foregoing disclosure. The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, and/or use of equivalent functional actions for actions described herein. Such insubstantial variations are to be considered within the scope of the claims below.

Given the above disclosure of general concepts and specific embodiments, the scope of protection is defined by the claims appended hereto. The issued claims are not to be taken as limiting Applicant's right to claim disclosed, but not yet literally claimed subject matter by way of one or more further applications including those filed pursuant to the laws of the United States and/or international treaty.

What is claimed is:

1. An above-ground vertical farming system for installation on a surface in an outdoor environment, the system comprising:
a structure including i) a bed comprising a horizontal platform at a lower end of the bed and ii) a framework coupled to the bed and configured to maintain the bed in a position elevated from a surface while the framework is in contact with the surface, wherein the platform comprises a floor surrounded by at least one wall and the bed comprises at least one flowpath configured to allow drainage of water from the lower end of the bed; and
a reservoir positioned with respect to the structure with an upper end of the reservoir surrounding at least a portion of the lower end of the bed proximate the floor of the bed and a lower end of the reservoir positioned at a point lower than the bed.

2. The system of claim 1 further comprising a growth medium contained in the bed wherein the system is configured to introduce water from the reservoir to the growth medium when the reservoir is filled with a threshold volume of water.

3. The system of claim 2 wherein the system is configured to introduce water from the reservoir to the growth medium via capillary processes.

4. The system of claim 1 wherein the at least one flowpath comprises at least one of: i) a conduit, ii) a port defined by at least one surface of the bed, iii) a capillary hole defined by at least one surface of the bed, iv) a capillary slot defined by at least one surface of the bed, and iv) a water permeable material.

5. The system of claim 1 wherein the structure is configured to enable movement of water from the reservoir into a growth medium received in the bed through capillary processes.

6. The system of claim 1 wherein the structure is configured to support a load of a heavy growth medium received in the bed.

7. The system of claim 1 wherein the reservoir is coupled to the framework.

8. The system of claim 1 wherein the reservoir is coupled to the bed.

9. The system of claim 1 wherein the reservoir comprises a container including raised sides and a plurality of substantially vertically oriented poles supporting the container in an elevated position with respect to the structure with the upper end of the reservoir surrounding at least the portion of the lower end of the bed proximate the floor of the bed and the lower end of the reservoir positioned at the point lower than the bed.

10. The system of claim 1 wherein the structure defines a gap between the framework and at least a portion of the at least one wall sufficient to allow an upper end of the reservoir to be positioned between the framework and the portion of the at least one wall while surrounding the lower end of the bed proximate the floor of the bed.

11. An above-ground vertical farming apparatus for attachment to a bed comprising a horizontal platform at a lower end of the bed, the platform comprising a floor surrounded by at least one wall, the bed elevated from a surface in an outdoor environment, the apparatus comprising:
a reservoir comprising an alignment means to align the reservoir elevated from the surface with an upper end of the reservoir surrounding at least a portion of the lower end of the bed proximate the floor of the bed and a lower end of the reservoir positioned at a point lower than the bed.

12. The apparatus of claim 1 further comprising a framework adapted for connection to the bed and configured to maintain the bed in a position elevated from the surface while the framework is in contact with the surface.

13. A modular above-ground vertical farming structure for use in an outdoor environment, comprising:
a rigid top bed;
at least one rigid shaded bed; and
a framework adapted for mechanical coupling to the top bed and the at least one shaded bed such that, when coupled, the framework supports the top bed and the at least one shaded bed and maintains the top bed and the at least one shaded bed in vertically stacked alignment, the framework comprising a plurality of supports;
wherein the top bed and the at least one shaded bed each comprise a horizontal platform with a top surface surrounded by at least one wall and configured to support a load of a heavy plant growth medium received in each of the top bed and the at least one shaded bed;
a reservoir coupled to the structure and configured to prevent water percolating from the rigid top bed to the at least one rigid shaded bed.

14. The structure of claim 13, further wherein the structure is configured to introduce water from the reservoir to the heavy growth medium when the heavy growth medium is in the bed and the reservoir is filled with a threshold volume of water.

15. The structure of claim 14 wherein the structure is configured to introduce water from the reservoir to the growth medium via capillary processes.
